(19) United States
(12) Patent Application Publication
(10) Pub. No.: US 2026/0168957 A1
(43) Pub. Date: Jun. 18, 2026

(54) GAS SENSOR AND SENSOR ELEMENT

(71) Applicant: NGK INSULATORS, LTD., Nagoya-shi (JP)

(72) Inventors: Shingo TANAKA, Kasugai-shi (JP); Yusuke WATANABE, Nagoya-shi (JP)

(21) Appl. No.: 19/399,722

(22) Filed: Nov. 25, 2025

(30) Foreign Application Priority Data
Dec. 12, 2024 (JP) 2024-218202

(51) Int. Cl. G01N 27/41; G01N 27/407

(52) U.S. Cl. CPC G01N 27/41; G01N 27/4075

(57) ABSTRACT

A gas sensor includes a sensor element and a control device, and configured to measure a concentration of a specific gas in a measurement gas, wherein the control device measures, as the concentration of the specific gas, at least two of a first to fourth concentrations by performing at least two types of the following concentration measurement processing, the at least two types being selected in a combination that uses all of a first to third pump currents: a first concentration measurement processing in which a first concentration is measured; a second concentration measurement processing in which a second concentration is measured; a third concentration measurement processing in which a third concentration is measured; and a fourth concentration measurement processing in which a fourth concentration is measured.

### CROSS-REFERENCE TO RELATED APPLICATION

This application is based on the priority of Japanese Patent Application No. 2024-218202, filed Dec. 12, 2024, the entire contents of which are incorporated herein by reference.

### BACKGROUND OF THE INVENTION

### 1. Field of the Invention

The present invention relates a gas sensor and a sensor element.

### 2. Description of the Related Art

Hitherto, a gas sensor that measures the concentration of carbon dioxide in a measurement gas such as exhaust gas from an automobile have been known. For example, PTL 1 describes a gas sensor comprising a sensor element including an oxygen-ion-conductive solid electrolyte layer, which specifies the concentrations of water vapor components and carbon dioxide components in the measurement gas. In this gas sensor, the oxygen partial pressure in a first internal cavity of a sensor element is adjusted so that all of the water vapor component and the carbon dioxide component in the measurement gas are substantially decomposed in the first internal cavity. The gas sensor then supplies oxygen to a second internal cavity which is in communication with the first internal cavity by a first measurement electrochemical pumping cell so that the hydrogen generated by decomposition of the water vapor component is selectively burned in the second internal cavity, and identifies the concentration of the water vapor component present in the measurement gas based on the magnitude of a current flowing then. In addition, this gas sensor supplies oxygen to the surface of a second measurement inner electrode by a second measurement electrochemical pumping cell so that the carbon monoxide generated by decomposition of the carbon dioxide component is selectively burned in a third internal cavity which is in communication with the second internal cavity, and identifies the concentration of the carbon dioxide component present in the measurement-object gas based on the magnitude of a current flowing then.

### CITATION LIST

### Patent Literature

PTL 1: JP 5918177 B

### SUMMARY OF THE INVENTION

In the gas sensor of PTL 1, as described above, the first internal cavity, the second internal cavity, and the third internal cavity inside the sensor element communicate with each other. In this case, water (water vapor) produced by combustion of hydrogen in the second internal cavity and carbon dioxide produced by combustion of carbon monoxide in the third internal cavity may reach the first internal cavity due to back diffusion (backflow). Then, hydrogen and carbon monoxide generated by decomposition (reduction) again of the water and the carbon dioxide that have reached the first internal cavity due to back diffusion may respectively reach the second internal cavity and the third internal cavity and combust again, whereby it has been found that measurement accuracy of the water concentration (concentration of the water vapor component) and the carbon dioxide concentration in the measurement gas may decrease. Accordingly, it has been desired to suppress the decrease in measurement accuracy of the concentration of the specific gas in the measurement gas due to such back diffusion.

The present invention was made to solve such a problem, and its main object is to suppress the decrease in measurement accuracy of the concentration of the specific gas in the measurement gas.

The present invention employs the following configuration to achieve the above-described main object.

[1] A first gas sensor of the present invention is a gas sensor including a sensor element and a control device, and configured to measure a concentration of a specific gas in a measurement gas, wherein: the sensor element includes: an element body having an oxygen-ion-conductive solid electrolyte layer and having, inside the element body, a first chamber, a second chamber, and a third chamber that are not in communication with each other and that are each reachable by the measurement gas from outside the sensor element; a first pump cell constituted including a first inner electrode disposed in the first chamber and a first outer electrode disposed on an outer surface of the element body; a second pump cell constituted including a second inner electrode disposed in the second chamber and a second outer electrode disposed on an outer surface of the element body; and a third pump cell constituted including a third inner electrode disposed in the third chamber and a third outer electrode disposed on an outer surface of the element body; the control device performs: a first pump cell control processing in which oxygen is pumped out from around the first inner electrode to around the first outer electrode by controlling the first pump cell, thereby reducing reduction target gases that are oxide gases of two or more kinds in the measurement gas in the first chamber; a second pump cell control processing in which, by controlling the second pump cell, oxygen is pumped out from around the second inner electrode to around the second outer electrode, while suppressing, as compared with the first pump cell control processing, the reduction of a first gas species in the measurement gas in the second chamber, the first gas species being one or more kinds of oxide gas included among the reduction target gases, but not all kinds thereof; and a third pump cell control processing in which, by controlling the third pump cell, oxygen is pumped out from around the third inner electrode to around the third outer electrode, while suppressing, as compared with the second pump cell control processing, the reduction of a second gas species in the measurement gas in the third chamber, the second gas species being one or more kinds of oxide gas other than the first gas species, included among the reduction target gases; and the control device measures, as the concentration of the specific gas, at least two of the first to fourth concentrations by performing at least two types of the following concentration measurement processing, the at least two types being selected in a combination that uses all of the first to third pump currents: a first concentration measurement processing in which a first concentration, which is a concentration of the first gas species in the measurement gas, is measured based on a first pump current that flows through the first pump cell by the first pump cell control processing and a second pump current that flows through the second pump cell by the second pump cell control processing; a second concentration measurement processing in which a second concentration, which is a concentration of the second gas species in the measurement gas, is measured based on the second pump current and a third pump current that flows through the third pump cell by the third pump cell control processing; a third concentration measurement processing in which a third concentration, which is a total concentration of the reduction target gases other than the first gas species and the second gas species and oxygen in the measurement gas, is measured based on the third pump current; and a fourth concentration measurement processing in which a fourth concentration, which is a total concentration of the first gas species and the second gas species in the measurement gas, is measured based on the first pump current and the third pump current.

In this first gas sensor, the control device measures at least two of the first to fourth concentrations based on the first to third pump currents by performing at least two of the first to fourth concentration measurement processing, the at least two types being selected in a combination that uses all of the first to third pump currents. Here, the first pump current flowing through the first pump cell by the first pump cell control processing correlates with a total concentration of the reduction target gases and oxygen in the measurement gas. The second pump current flowing through the second pump cell by the second pump cell control processing correlates with a total concentration of the reduction target gases other than the first gas species and oxygen in the measurement gas. The third pump current flowing through the third pump cell by the third pump cell control processing correlates with a total concentration of the reduction target gases other than the first gas species and the second gas species and oxygen in the measurement gas. Therefore, based on the first pump current and the second pump current, it is possible to measure the first concentration that is the concentration of the first gas species in the measurement gas. Further, based on the second pump current and the third pump current, it is possible to measure the second concentration that is the concentration of the second gas species in the measurement gas. Based on the third pump current, it is possible to measure the third concentration that is the total concentration of the reduction target gases other than the first gas species and the second gas species and oxygen in the measurement gas. Based on the first pump current and the third pump current, it is possible to measure the fourth concentration that is the total concentration of the first gas species and the second gas species in the measurement gas. Moreover, the first chamber, the second chamber, and the third chamber are not in communication with each other, and the measurement gas reaches the first chamber, the second chamber, and the third chamber through respective independent routes from outside the sensor element. Therefore, it is possible to suppress gases in the first chamber, the second chamber, and the third chamber from mutually affecting one another, and the decrease in measurement accuracy due to the back diffusion described above is less likely to occur. Accordingly, in this gas sensor, it is possible to suppress the decrease in measurement accuracy of the concentration of the specific gas in the measurement gas.

Note that when the first gas species is two or more kinds of oxide gases among the reduction target gases, the first concentration is a total concentration of those two or more kinds of oxide gases. In addition, since the second gas species is one or more kinds of oxide gases among the reduction target gases other than the first gas species, there is also an aspect in which the second gas species is all kinds of oxide gases among the reduction target gases other than the first gas species. In this aspect, since “the reduction target gases other than the first gas species and the second gas species in the measurement gas” do not exist, an oxygen concentration in the measurement gas becomes the third concentration. The first gas species may be one or more kinds of oxide gases selected in order from an oxide gas least likely to be reduced among the reduction target gases. The second gas species may be one or more kinds of oxide gases selected in order from an oxide gas least likely to be reduced among the reduction target gases excluding the first gas species.

[2] In the first gas sensor described above (the gas sensor described in [1]), the reduction target gases may be water and carbon dioxide, the first gas species may be carbon dioxide, and the second gas species may be water.

[3] In the first gas sensor described above (the gas sensor described in [2]), the second inner electrode may contain a first type of noble metal with catalytic activity and a second type of noble metal that suppresses reduction of carbon dioxide. By the second inner electrode containing the second type of noble metal in addition to the first type of noble metal, the second pump current becomes less susceptible to an influence of a carbon dioxide concentration in the measurement gas. Therefore, measurement accuracy of the first concentration measurement processing, that is, measurement accuracy of the carbon dioxide concentration based on the first pump current and the second pump current, is improved. In this case, the first inner electrode may contain the first type of noble metal.

[4] In the first gas sensor described above (the gas sensor described in [3]), the first type of noble metal may be at least one of Pt, Rh, Ir, Ru, and Pd, and the second type of noble metal may be Au.

[5] In the first gas sensor described above (the gas sensor described in [3] or [4]), the second inner electrode may have a ratio R2 calculated by the following Expression (1) of 2% or more. By the ratio R2 of the second inner electrode being 2% or more, it is possible to more reliably weaken a reduction capability of the second inner electrode with respect to carbon dioxide.

$$R 2 = S 2 / {( S 1 + S 2 )}^{*} 1 θθ \qquad ( 1 )$$

where: S1: mass ratio [wt %] of the first type of noble metal; and S2: mass ratio [wt %] of the second type of noble metal

[6] In the first gas sensor described above (the gas sensor described in any one of [1] to [5]), the sensor element may include a reference electrode disposed inside the element body so as to be in contact with a reference gas, and the control device may control: in the first pump cell control processing, the first pump cell such that a first voltage, which is a voltage between the reference electrode and the first inner electrode, reaches a first voltage target value; in the second pump cell control processing, the second pump cell such that a second voltage, which is a voltage between the reference electrode and the second inner electrode, reaches a second voltage target value whose absolute value is smaller than the absolute value of the first voltage target value; and in the third pump cell control processing, the third pump cell such that a third voltage, which is a voltage between the reference electrode and the third inner electrode, reaches a third voltage target value whose absolute value is smaller than the absolute value of the second voltage target value.

[7] In the first gas sensor described above (the gas sensor described in any one of [1] to [6]), the first concentration measurement processing may be processing that measures the first concentration based on a difference between the first pump current and the second pump current, or processing that measures the first concentration based on a difference between a total concentration of the reduction target gases and oxygen in the measurement gas derived based on the first pump current and a total concentration of the reduction target gases other than the first gas species and oxygen in the measurement gas derived based on the second pump current. The second concentration measurement processing may be processing that measures the second concentration based on a difference between the second pump current and the third pump current, or processing that measures the second concentration based on a difference between a total concentration of the reduction target gases other than the first gas species and oxygen in the measurement gas derived based on the second pump current and a total concentration of the reduction target gases other than the first gas species and the second gas species and oxygen in the measurement gas derived based on the third pump current. The fourth concentration measurement processing may be processing that measures the fourth concentration based on a difference between the first pump current and the third pump current, or processing that measures the fourth concentration based on a difference between a total concentration of the reduction target gases and oxygen in the measurement gas derived based on the first pump current and a total concentration of the reduction target gases other than the first gas species and the second gas species and oxygen in the measurement gas derived based on the third pump current. Note that “the processing that measures the first concentration based on a difference between the first pump current and the second pump current” includes “processing that measures the first concentration based on a difference derived after correcting at least one of the first pump current and the second pump current.” “The processing that measures the second concentration based on a difference between the second pump current and the third pump current” includes “processing that measures the second concentration based on a difference derived after correcting at least one of the second pump current and the third pump current.” “The processing that measures the fourth concentration based on a difference between the first pump current and the third pump current” includes “processing that measures the fourth concentration based on a difference derived after correcting at least one of the first pump current and the third pump current.”

[8] In the first gas sensor described above (the gas sensor described in any one of [1] to [7]), the element body may have a rectangular parallelepiped shape having first to sixth surfaces as outer surfaces, the element body may include a first inlet that is an inlet of the measurement gas from outside to the first chamber, a second inlet that is an inlet of the measurement gas from outside to the second chamber, and a third inlet that is an inlet of the measurement gas from outside to the third chamber, and the first inlet, the second inlet, and the third inlet open on mutually different surfaces among the first to sixth surfaces. In this way, it is possible to further suppress gases in the first chamber, the second chamber, and the third chamber from mutually affecting one another.

[9] In the first gas sensor described above (the gas sensor described in any one of [1] to [7]), the element body may have a rectangular parallelepiped shape having first to sixth surfaces as outer surfaces, the element body may include a first inlet that is an inlet of the measurement gas from outside to the first chamber, a second inlet that is an inlet of the measurement gas from outside to the second chamber, and a third inlet that is an inlet of the measurement gas from outside to the third chamber, and the first inlet, the second inlet, and the third inlet open on a same surface among the first to sixth surfaces. In this way, even when a concentration of a specific gas in the measurement gas fluctuates in a short time, the measurement gas reaching each of the first to third chambers is likely to have the same concentration of a specific gas. Accordingly, measurement accuracy of concentrations (the first, the second, and the fourth concentrations) measured based on two among the first to third pump currents is improved.

[10] A second gas sensor of the present invention is a gas sensor including a sensor element and a control device, and configured to measure a concentration of a specific gas in a measurement gas, wherein: the sensor element includes: an element body having an oxygen-ion-conductive solid electrolyte layer and having, inside the element body, a first chamber and a second chamber that are not in communication with each other and that are each reachable by the measurement gas from outside the sensor element; a first pump cell constituted including a first inner electrode disposed in the first chamber and a first outer electrode disposed on an outer surface of the element body; a second pump cell constituted including a second inner electrode disposed in the second chamber and a second outer electrode disposed on an outer surface of the element body; and the control device performs: a first pump cell control processing in which oxygen is pumped out from around the first inner electrode to around the first outer electrode by controlling the first pump cell, thereby reducing reduction target gas that includes at least water among water and carbon dioxide in the measurement gas in the first chamber; a second pump cell control processing in which, by controlling the second pump cell, oxygen is pumped out from around the second inner electrode to around the second outer electrode, while suppressing, as compared with the first pump cell control processing, the reduction of a first gas species in the measurement gas in the second chamber, the first gas species being one or more kinds of gas included among the reduction target gas; and a concentration measurement processing in which a first concentration as the concentration of the specific gas, which is a concentration of the first gas species in the measurement gas, is measured based on a first pump current that flows through the first pump cell by the first pump cell control processing and a second pump current that flows through the second pump cell by the second pump cell control processing; and the first gas species is water when the reduction target gas is water, and the first gas species is one or more kinds of gases including at least carbon dioxide among the reduction target gas when the reduction target gas is water and carbon dioxide.

In this second gas sensor, the control device measures, based on the first pump current and the second pump current, the first concentration that is the concentration of the first gas species in the measurement gas. Here, the first pump current flowing through the first pump cell by the first pump cell control processing correlates with a total concentration of the reduction target gases and oxygen in the measurement gas. The second pump current flowing through the second pump cell by the second pump cell control processing correlates with a total concentration of the reduction target gases other than the first gas species and oxygen in the measurement gas. Therefore, based on the first pump current and the second pump current, it is possible to measure, as the concentration of the specific gas, the first concentration that is the concentration of the first gas species in the measurement gas. Moreover, the first chamber and the second chamber are not in communication with each other, and the measurement gas reaches the first chamber and the second chamber through respectively independent routes from outside the sensor element. Therefore, it is possible to suppress gases in the first chamber and the second chamber from mutually affecting one another, and the decrease in measurement accuracy due to the back diffusion described above is less likely to occur. Accordingly, in this gas sensor, it is possible to suppress the decrease in measurement accuracy of the concentration of the specific gas in the measurement gas. The reduction target gases include at least water among water and carbon dioxide. That is, the reduction target gases are water, or are water and carbon dioxide. When the reduction target gases are water, the first gas species is water. When the reduction target gases are water and carbon dioxide, the first gas species is one or more kinds among the reduction target gases including at least carbon dioxide. That is, when the reduction target gases are water and carbon dioxide, the first gas species is carbon dioxide, or is water and carbon dioxide. When the first gas species is water and carbon dioxide, the first concentration is a total concentration of water and carbon dioxide in the measurement gas. In the second gas sensor, aspects similar to various aspects of the first gas sensor described above may be adopted, and configurations similar to the first gas sensor described above may be added.

[11] A sensor element of the present invention is a sensor element for measuring a concentration of a specific gas in a measurement gas, the sensor element including: an element body having an oxygen-ion-conductive solid electrolyte layer and having, inside the element body, a first chamber, a second chamber, and a third chamber that are not in communication with each other and that are each reachable by the measurement gas from outside; a first pump cell constituted including a first inner electrode disposed in the first chamber and a first outer electrode disposed on an outer surface of the element body; a second pump cell constituted including a second inner electrode disposed in the second chamber and a second outer electrode disposed on an outer surface of the element body; and a third pump cell constituted including a third inner electrode disposed in the third chamber and a third outer electrode disposed on an outer surface of the element body.

This sensor element, similarly to the sensor element of the first gas sensor described above, has the first chamber, the second chamber, and the third chamber not communicating with each other, and the measurement gas from outside the sensor element reaches the first chamber, the second chamber, and the third chamber via respectively independent routes. Therefore, it is possible to suppress gases in the first chamber, the second chamber, and the third chamber from mutually affecting one another, and a decrease in measurement accuracy due to the back diffusion described above is less likely to occur. Therefore, the sensor element of the present invention is suitable as the sensor element used in the first gas sensor described above. Note that, in the sensor element of the present invention, aspects similar to various aspects of the sensor element in the first gas sensor described above may be adopted, and similar configurations may be added.

### BRIEF DESCRIPTION OF THE DRAWINGS

FIG. 1 is a schematic cross-sectional view schematically illustrating an example of the configuration of a gas sensor 100.

FIG. 2 is a partial cross-sectional view of the spacer layer 5 of FIG. 1.

FIG. 3 is a block diagram showing an electrical connection relationship among a control device 95, respective cells, and a heater 72.

FIG. 4 is an explanatory diagram showing an example of V-I characteristics of pump cells (first to third measurement pump cells 15, 25, 35).

FIG. 5 is an explanatory diagram showing an example of V-I characteristics when inner electrodes (first to third measurement electrodes 16, 26, 36) contain a second type of noble metal.

FIG. 6 is a partial cross-sectional view of an element body 102 in a modified example.

FIG. 7 is a schematic cross-sectional view of the element body 102 in a modified example.

### DETAILED DESCRIPTION OF THE INVENTION

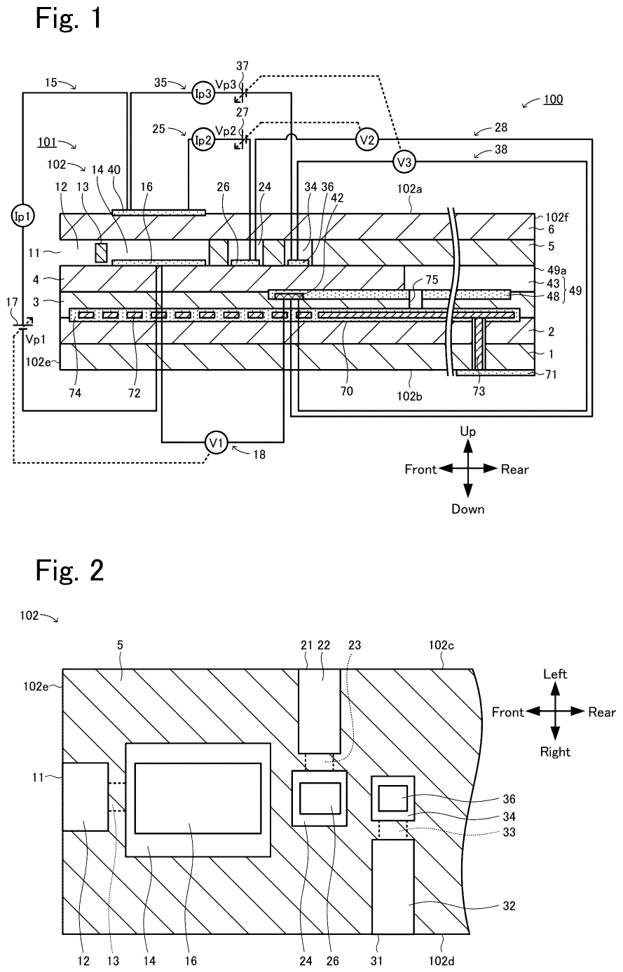

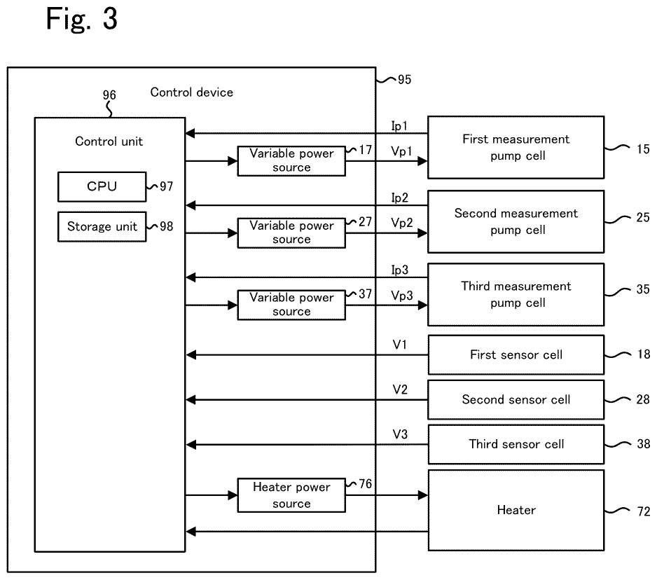

Next, embodiments of the present invention will be described with reference to the drawings. FIG. 1 is a schematic cross-sectional view schematically illustrating an example of the configuration of a gas sensor 100 according to one embodiment of the present invention. FIG. 2 is a partial cross-sectional view of the spacer layer 5 of FIG. 1. FIG. 3 is a block diagram showing an electrical connection relationship among a control device 95, respective cells, and a heater 72. Note that FIG. 2 is a partial cross-sectional view as seen from above around the first to third internal cavities 14, 24, and 34 among cross sections taken along the front-rear and left-right directions of the spacer layer 5. In FIG. 2, for reference, first to third diffusion rate-limiting sections 13, 23, and 33 are indicated by dotted lines. The gas sensor 100 is mounted, for example, to a pipe such as an exhaust gas pipe of an internal combustion engine. The gas sensor 100 uses exhaust gas of the internal combustion engine as a measurement gas and detects a concentration of a specific gas in the measurement gas. In this embodiment, the gas sensor 100 measures, as the concentration of a specific gas, a carbon dioxide concentration, a water concentration, an oxygen concentration, and a total concentration of carbon dioxide and water.

The gas sensor 100 includes: a sensor element 101 having an element body 102 in an elongated rectangular-parallelepiped shape; respective cells 15, 25, 35, 18, 28, and 38 provided in the sensor element 101; a heater section 70 provided inside the sensor element 101; a control device 95 that has variable power sources 17, 27, and 37 and a heater power source 76 and controls the entire gas sensor 100. Here, a longitudinal direction of the sensor element 101 (a left-right direction in FIG. 1) is a front-rear direction, a thickness direction of the sensor element 101 (an up-down direction in FIG. 1) is an up-down direction, and a width direction of the sensor element 101 (a direction perpendicular to the front-rear direction and the up-down direction, that is, an up-down direction in FIG. 2) is a left-right direction. Since the element body 102 is a rectangular parallelepiped, as shown in FIGS. 1 and 2, the element body 102 has six surfaces as its outer surface: a first surface 102a (upper surface), a second surface 102b (lower surface), a third surface 102c (left side surface), a fourth surface 102d (right side surface), a fifth surface 102e (front end surface), and a sixth surface 102f (rear end surface).

The element body 102 is a laminate in which six layers are laminated in this order from the lower side in the drawings: a first substrate layer 1, a second substrate layer 2, a third substrate layer 3, a first solid electrolyte layer 4, a spacer layer 5, and a second solid electrolyte layer 6, each of which is an oxygen ion-conductive solid electrolyte layer such as zirconia (ZrO₂). The solid electrolytes forming these six layers are dense and hermetic. The element body 102 is manufactured, for example, by laminating ceramic green sheets corresponding to the respective layers after performing predetermined processing and printing of circuit patterns thereon, and further firing them to be integrated.

On a front-end side of the sensor element 101 (the element body 102), a first gas inlet 11, a first buffer space 12, a first diffusion rate-limiting section 13, and a first internal cavity 14 are formed adjacent to one another between a lower surface of the second solid electrolyte layer 6 and an upper surface of the first solid electrolyte layer 4 so as to communicate in this order from the front toward the rear. Similarly, between the lower surface of the second solid electrolyte layer 6 and the upper surface of the first solid electrolyte layer 4, a second gas inlet 21, a second buffer space 22, a second diffusion rate-limiting section 23, and a second internal cavity 24 are formed adjacent to one another so as to communicate in this order from the left toward the right. Further, between the lower surface of the second solid electrolyte layer 6 and the upper surface of the first solid electrolyte layer 4, a third gas inlet 31, a third buffer space 32, a third diffusion rate-limiting section 33, and a third internal cavity 34 are formed adjacent to one another so as to communicate in this order from the right toward the left.

The first gas inlet 11 is an inlet of the measurement gas from outside the sensor element 101 to the first internal cavity 14, and opens on the fifth surface 102e in this embodiment. The second gas inlet 21 is an inlet of the measurement gas from outside the sensor element 101 to the second internal cavity 24, and opens on the third surface 102c in this embodiment. The third gas inlet 31 is an inlet of the measurement gas from outside the sensor element 101 to the third internal cavity 34, and opens on the fourth surface 102d in this embodiment. Accordingly, in this embodiment, the first gas inlet 11, the second gas inlet 21, and the third gas inlet 31 open on mutually different surfaces among the first to sixth surfaces 102a to 102f.

The first to third gas inlets 11, 21, and 31, the first to third buffer spaces 12, 22, and 32, and the first to third internal cavities 14, 24, and 34 are spaces inside the sensor element 101 that are provided by hollowing out the spacer layer 5 and are partitioned by a lower surface of the second solid electrolyte layer 6 as an upper side, an upper surface of the first solid electrolyte layer 4 as a lower side, and side surfaces of the spacer layer 5 as side portions.

The first diffusion rate-limiting section 13 is provided as two laterally elongated slits (with openings oriented along the longitudinal direction perpendicular to the drawing plane of FIG. 1). As shown in FIG. 1, the two slits of the first diffusion rate-limiting section 13 are provided as a gap between the lower surface of the second solid electrolyte layer 6 and the upper surface of the spacer layer 5, and as a gap between the upper surface of the first solid electrolyte layer 4 and the lower surface of the spacer layer 5. Although not shown, the second diffusion rate-limiting section 23 and the third diffusion rate-limiting section 33 are also each provided as two laterally elongated slits (with openings oriented along the longitudinal direction perpendicular to the drawing plane of FIG. 1), similarly to the first diffusion rate-limiting section 13.

The first buffer space 12 is a space provided to guide the measurement gas introduced from the first gas inlet 11 to the first diffusion rate-limiting section 13. In this embodiment, the first buffer space 12 opens on the fifth surface 102e, and this opening serves as the first gas inlet 11. The first diffusion rate-limiting section 13 is a site that imparts a predetermined diffusion resistance to the measurement gas introduced from the first buffer space 12 into the first internal cavity 14. The second buffer space 22 is a space provided to guide the measurement gas introduced from the second gas inlet 21 to the second diffusion rate-limiting section 23. In this embodiment, the second buffer space 22 opens on the third surface 102c, and this opening serves as the second gas inlet 21. The second diffusion rate-limiting section 23 is a site that imparts a predetermined diffusion resistance to the measurement gas introduced from the second buffer space 22 into the second internal cavity 24. The third buffer space 32 is a space provided to guide the measurement gas introduced from the third gas inlet 31 to the third diffusion rate-limiting section 33. In this embodiment, the third buffer space 32 opens on the fourth surface 102d, and this opening serves as the third gas inlet 31. The third diffusion rate-limiting section 33 is a site that imparts a predetermined diffusion resistance to the measurement gas introduced from the third buffer space 32 into the third internal cavity 34.

When the measurement gas is introduced from outside the sensor element 101 into the first internal cavity 14, the measurement gas that is abruptly taken into the inside of the sensor element 101 through the first gas inlet 11 due to pressure fluctuations of the measurement gas in an external space (if the measurement gas is exhaust gas of an automobile, pulsation of exhaust pressure) is not directly introduced into the first internal cavity 14, but is introduced into the first internal cavity 14 after the pressure fluctuations of the measurement gas are canceled through the first buffer space 12 and the first diffusion rate-limiting section 13. As a result, pressure fluctuations of the measurement gas introduced into the first internal cavity 14 become almost negligible. Similarly, the measurement gas introduced into the inside of the sensor element 101 through the second gas inlet 21 is introduced into the second internal cavity 24 after the pressure fluctuations are canceled through the second buffer space 22 and the second diffusion rate-limiting section 23. The measurement gas introduced into the inside of the sensor element 101 through the third gas inlet 31 is introduced into the third internal cavity 34 after the pressure fluctuations are canceled through the third buffer space 32 and the third diffusion rate-limiting section 33.

A portion from outside the sensor element 101 to the first internal cavity 14 (here, the first gas inlet 11, the first buffer space 12, and the first diffusion rate-limiting section 13) is also referred to as a first measurement gas flow path. A portion from outside the sensor element 101 to the second internal cavity 24 (here, the second gas inlet 21, the second buffer space 22, and the second diffusion rate-limiting section 23) is also referred to as a second measurement gas flow path. A portion from outside the sensor element 101 to the third internal cavity 34 (here, the third gas inlet 31, the third buffer space 32, and the third diffusion rate-limiting section 33) is also referred to as a third measurement gas flow path. The first internal cavity 14 is reachable by the measurement gas from outside the sensor element 101 through this first measurement gas flow path. The second internal cavity 24 is reachable by the measurement gas from outside the sensor element 101 through this second measurement gas flow path. The third internal cavity 34 is reachable by the measurement gas from outside the sensor element 101 through this third measurement gas flow path. As shown in FIGS. 1 and 2, the first internal cavity 14, the second internal cavity 24, and the third internal cavity 34 are provided independently inside the element body 102 without being in communication with one another. More specifically, the first measurement gas flow path, the second measurement gas flow path, and the third measurement gas flow path are not in communication with one another, and, inside the element body 102, there is no gas flow path that allows the measurement gas to flow between at least two of the first internal cavity 14, the second internal cavity 24, and the third internal cavity 34. Therefore, the measurement gas reaches the first internal cavity 14, the second internal cavity 24, and the third internal cavity 34 from outside the sensor element 101 via respective independent routes (the first to third measurement gas flow paths).

The sensor element 101 (the element body 102) includes a reference gas introduction portion 49 for causing, from outside the sensor element 101, a reference gas to flow to a reference electrode 42 when measuring a concentration of a specific gas. The reference gas introduction portion 49 has a reference gas introduction space 43 and a reference gas introduction layer 48. The reference gas introduction space 43 is a space provided inward from the sixth surface 102f of the sensor element 101. The reference gas introduction space 43 is provided at a position between an upper surface of the third substrate layer 3 and a lower surface of the spacer layer 5, with sides partitioned by a side surface of the first solid electrolyte layer 4. The reference gas introduction space 43 opens on the sixth surface 102f of the sensor element 101, and this opening functions as an inlet portion 49a of the reference gas introduction portion 49. The reference gas is introduced into the reference gas introduction space 43 from this inlet portion 49a. The reference gas introduction portion 49 introduces the reference gas introduced from the inlet portion 49a to the reference electrode 42 while imparting a predetermined diffusion resistance thereto. In this embodiment, the reference gas is ambient air.

The reference gas introduction layer 48 is provided between an upper surface of the third substrate layer 3 and a lower surface of the first solid electrolyte layer 4. The reference gas introduction layer 48 is a porous body made of ceramics such as alumina, for example. A part of an upper surface of the reference gas introduction layer 48 is exposed in the reference gas introduction space 43. The reference gas introduction layer 48 is formed so as to cover the reference electrode 42. The reference gas introduction layer 48 causes the reference gas to flow from the reference gas introduction space 43 to the reference electrode 42.

The reference electrode 42 is an electrode formed in a manner sandwiched between an upper surface of the third substrate layer 3 and the first solid electrolyte layer 4, and, as described above, around it, the reference gas introduction layer 48 leading to the reference gas introduction space 43 is provided. As will be described later, it is possible to measure an oxygen concentration (oxygen partial pressure) in the first internal cavity 14, the second internal cavity 24, and the third internal cavity 34 by using the reference electrode 42.

The first internal cavity 14 is provided as a space for adjusting an oxygen partial pressure in the measurement gas introduced through the first diffusion rate-limiting section 13. The oxygen partial pressure is adjusted by operation of a first measurement pump cell 15. The second internal cavity 24 is provided as a space for adjusting an oxygen partial pressure in the measurement gas introduced through the second diffusion rate-limiting section 23. The oxygen partial pressure is adjusted by operation of a second measurement pump cell 25. The third internal cavity 34 is provided as a space for adjusting an oxygen partial pressure in the measurement gas introduced through the third diffusion rate-limiting section 33. The oxygen partial pressure is adjusted by operation of a third measurement pump cell 35.

The first measurement pump cell 15 is an electrochemical pump cell constituted by a first measurement electrode 16, an outer pump electrode 40, and a second solid electrolyte layer 6, the spacer layer 5, and the first solid electrolyte layer 4 that form a current path between these electrodes. The first measurement electrode 16 is disposed in the first internal cavity 14 and is disposed so as to cover most of a region, among upper surfaces of the first solid electrolyte layer 4, that faces the first internal cavity 14 (that is, a region forming a bottom surface of the first internal cavity 14). The outer pump electrode 40 is an electrode disposed on the first surface 102a among the outer surfaces of the element body 102. Although the outer pump electrode 40 is disposed in a manner exposed to the outside of the sensor element 101, it may be covered with a protective layer that is a porous body through which the measurement gas can pass.

In the first measurement pump cell 15, by applying a desired voltage Vp1 between the first measurement electrode 16 and the outer pump electrode 40 and causing a pump current Ip1 to flow in a positive direction or a negative direction between the first measurement electrode 16 and the outer pump electrode 40, it is possible to pump oxygen in the first internal cavity 14 out to an external space, or to pump oxygen of the external space into the first internal cavity 14.

Further, in order to detect an oxygen concentration (oxygen partial pressure) in an atmosphere in the first internal cavity 14, an electrochemical sensor cell, that is, a first sensor cell 18, is constituted by the first measurement electrode 16, the first solid electrolyte layer 4, the third substrate layer 3, and the reference electrode 42.

By measuring an electromotive force (voltage V1) between the first measurement electrode 16 and the reference electrode 42 in the first sensor cell 18, an oxygen concentration (oxygen partial pressure) inside the first internal cavity 14 can be known. Furthermore, by feedback-controlling the voltage Vp1 of the variable power source 17 so that the voltage V1 becomes a target value, the pump current Ip1 is controlled. As a result, the oxygen concentration inside the first internal cavity 14 is adjusted.

The second measurement pump cell 25 is an electrochemical pump cell constituted by a second measurement electrode 26, an outer pump electrode 40, and a second solid electrolyte layer 6, the spacer layer 5, and the first solid electrolyte layer 4 that serve as a current path between these electrodes. The second measurement electrode 26 is disposed in the second internal cavity 24 and is disposed so as to cover most of a region, among upper surfaces of the first solid electrolyte layer 4, that faces the second internal cavity 24 (that is, a region forming a bottom surface of the second internal cavity 24).

In the second measurement pump cell 25, by applying a desired voltage Vp2 between the second measurement electrode 26 and the outer pump electrode 40 and causing a pump current Ip2 to flow in a positive direction or a negative direction between the second measurement electrode 26 and the outer pump electrode 40, it is possible to pump oxygen in the second internal cavity 24 out to an external space, or to pump oxygen of the external space into the second internal cavity 24.

Further, in order to detect an oxygen concentration (oxygen partial pressure) in an atmosphere in the second internal cavity 24, an electrochemical sensor cell, that is, a second sensor cell 28, is constituted by the second measurement electrode 26, the first solid electrolyte layer 4, the third substrate layer 3, and the reference electrode 42.

By measuring an electromotive force (voltage V2) between the second measurement electrode 26 and the reference electrode 42 in the second sensor cell 28, an oxygen concentration (oxygen partial pressure) inside the second internal cavity 24 can be known. Furthermore, by feedback-controlling the voltage Vp2 of the variable power source 27 so that the voltage V2 becomes a target value, the pump current Ip2 is controlled. As a result, the oxygen concentration inside the second internal cavity 24 is adjusted.

The third measurement pump cell 35 is an electrochemical pump cell constituted by a third measurement electrode 36, an outer pump electrode 40, and a second solid electrolyte layer 6, the spacer layer 5, and the first solid electrolyte layer 4 that serve as a current path between these electrodes. The third measurement electrode 36 is disposed in the third internal cavity 34 and is disposed so as to cover most of a region, among upper surfaces of the first solid electrolyte layer 4, that faces the third internal cavity 34 (that is, a region forming a bottom surface of the third internal cavity 34).

In the third measurement pump cell 35, by applying a desired voltage Vp3 between the third measurement electrode 36 and the outer pump electrode 40 and causing a pump current Ip3 to flow in a positive direction or a negative direction between the third measurement electrode 36 and the outer pump electrode 40, it is possible to pump oxygen in the third internal cavity 34 out to an external space, or to pump oxygen of the external space into the third internal cavity 34.

Further, in order to detect an oxygen concentration (oxygen partial pressure) in an atmosphere in the third internal cavity 34, an electrochemical sensor cell, that is, a third sensor cell 38, is constituted by the third measurement electrode 36, the first solid electrolyte layer 4, the third substrate layer 3, and the reference electrode 42.

By measuring an electromotive force (voltage V3) between the third measurement electrode 36 and the reference electrode 42 in the third sensor cell 38, an oxygen concentration (oxygen partial pressure) inside the third internal cavity 34 can be known. Furthermore, by feedback-controlling the voltage Vp3 of the variable power source 37 so that the voltage V3 becomes a target value, the pump current Ip3 is controlled. As a result, the oxygen concentration inside the third internal cavity 34 is adjusted.

Here, each of the electrodes 16, 26, 36, 40, and 42 will be described. The first measurement electrode 16, the second measurement electrode 26, and the third measurement electrode 36 each contain a first type of noble metal with catalytic activity. As the first type of noble metal, at least one of, for example, Pt, Rh, Ir, Ru, and Pd can be cited. The outer pump electrode 40 and the reference electrode 42 also contain the first type of noble metal. It is preferable that the second measurement electrode 26 contain, in addition to the first type of noble metal, a second type of noble metal that suppresses catalytic activity of the first type of noble metal with respect to carbon dioxide. By the second measurement electrode 26 containing the second type of noble metal, a reducing capability of the second measurement electrode 26 with respect to carbon dioxide can be weakened. As the second type of noble metal, for example, Au can be cited. It is preferable that each of the electrodes 16, 26, 36, 40, and 42 be a cermet containing a noble metal and an oxygen ion-conductive oxide (for example, ZrO₂). It is preferable that each of the electrodes 16, 26, 36, 40, and 42 be a porous body. In this embodiment, each of the electrodes 16, 26, 36, 40, and 42 is a porous cermet electrode of Pt and ZrO₂ that contains no second type of noble metal.

When the second measurement electrode 26 contains the second type of noble metal, it is preferable that the ratio R2 calculated by the following formula (1) be 2% or more for the second measurement electrode 26. If the ratio R2 of the second measurement electrode 26 is 2% or more, a reducing capability of the second measurement electrode 26 with respect to carbon dioxide can be more reliably weakened. The ratio R2 of the second measurement electrode 26 may be 5% or more. The ratio R2 of the second measurement electrode 26 may be 10% or less, and may be 5% or less. Similarly to the ratio R2, a content ratio of the second type of noble metal in the first measurement electrode 16 is taken as a ratio R1, and a content ratio of the second type of noble metal in the third measurement electrode 36 is taken as a ratio R3. The ratios R1 and R3 are calculated in the same manner as the following formula (1). The ratios R1 to R3 are values measured using an electron probe microanalyzer (EPMA).

$$R 2 = S 2 / {( S 1 + S 2 )}^{*} 1 θθ \qquad ( 1 )$$

where:
S1: mass ratio [wt %] of the first type of noble metal; and
S2: mass ratio [wt %] of the second type of noble metal

The sensor element 101 includes a heater section 70 that performs temperature regulation by heating and maintaining the temperature of the sensor element 101, in order to enhance the oxygen-ion-conductivity of the solid electrolyte. The heater section 70 includes a heater connector electrode 71, a heater 72, a through hole 73, a heater insulating layer 74, and a pressure relief hole 75.

The heater connector electrode 71 is an electrode formed in such a manner as to be in contact with the lower surface of the first substrate layer 1. By connecting the heater connector electrode 71 to a heater power source 76 (see FIG. 3), power can be supplied from the heater power source 76 to the heater section 70.

The heater 72 is an electrical resistor formed in such a manner as to be sandwiched between the second substrate layer 2 and the third substrate layer 3 from above and below. The heater 72 is connected to the heater connector electrode 71 via the through hole 73, and generates heat when power is supplied from the heater power source 76 through the heater connector electrode 71, thereby heating and maintaining the temperature of the solid electrolyte forming the sensor element 101.

Further, the heater 72 is embedded over an entire region where the first internal cavity 14, the second internal cavity 24, and the third internal cavity 34 exist, and it is thereby possible to adjust an overall temperature of the sensor element 101 to a temperature at which the solid electrolyte becomes active.

The heater insulating layer 74 is an insulating layer formed of an insulator such as alumina and provided on the upper and lower surfaces of the heater 72. The heater insulating layer 74 is formed for the purpose of providing electrical insulation between the second substrate layer 2 and the heater 72, as well as between the third substrate layer 3 and the heater 72.

The pressure relief hole 75 is provided so as to penetrate the third substrate layer 3 and the reference-gas introduction layer 48 and to communicate with the reference-gas introduction space 43, and is formed for the purpose of alleviating an internal-pressure rise accompanying a temperature rise inside the heater insulating layer 74.

As shown in FIG. 3, the control device 95 includes the above-described variable power sources 17, 27, 37, the above-described heater power source 76, and a control unit 96. The control unit 96 is a microprocessor including a CPU 97 and a storage unit 98 and so forth. The storage unit 98 is a rewritable nonvolatile memory, and, for example, various programs and various data can be stored therein. The control unit 96 inputs a voltage V1 of the first sensor cell 18, a voltage V2 of the second sensor cell 28, a voltage V3 of the third sensor cell 38, a pump current Ip1 flowing through the first measurement pump cell 15, a pump current Ip2 flowing through the second measurement pump cell 25, and a pump current Ip3 flowing through the third measurement pump cell 35. Further, the control unit 96 controls voltages Vp1, Vp2, and Vp3 output by the variable power sources 17, 27, and 37 by outputting control signals to the variable power sources 17, 27, and 37, thereby controlling the first measurement pump cell 15, the second measurement pump cell 25, and the third measurement pump cell 35. The control unit 96 controls power supplied by the heater power source 76 to the heater 72 by outputting a control signal to the heater power source 76. Target values V1*, V2*, and V3*, described later, are also stored in the storage unit 98. The CPU 97 of the control unit 96 refers to these target values V1*, V2*, and V3* and performs control of the respective pump cells 15, 25, and 35.

The control unit 96 performs first measurement pump control processing that controls the first measurement pump cell 15 so as to pump oxygen from around the first measurement electrode 16 to around the outer pump electrode 40. Specifically, the control unit 96 controls the first measurement pump cell 15 by feedback-controlling the voltage Vp1 of the variable power source 17 so that the voltage V1 reaches the target value V1*. The target value V1* is defined as a value such that an oxygen concentration in the first internal cavity 14 becomes a predetermined low concentration sufficiently low to reduce substantially all reduction target gases that are two or more kinds of oxide gases in the measurement gas. In this embodiment, the reduction target gases are water and carbon dioxide. By performing this first measurement pump control processing, in the first internal cavity 14, water in the measurement gas is reduced to generate hydrogen and oxygen, and carbon dioxide in the measurement gas is reduced to generate carbon monoxide and oxygen. Then, the oxygen generated by these reductions and the oxygen existing in the measurement gas before the reductions are pumped from around the first measurement electrode 16 to around the outer pump electrode 40 by a pump current Ip1 flowing through the first measurement pump cell 15. Accordingly, the pump current Ip1 flowing through the first measurement pump cell 15 by the first measurement pump control processing is correlated with a total concentration of the reduction target gases and oxygen in the measurement gas.

The control unit 96 performs second measurement pump control processing that controls the second measurement pump cell 25 so as to pump oxygen from around the second measurement electrode 26 to around the outer pump electrode 40. Specifically, the control unit 96 controls the second measurement pump cell 25 by feedback-controlling the voltage Vp2 of the variable power source 27 so that the voltage V2 reaches the target value V2*. The target value V2* is defined as a value such that an oxygen concentration in the second internal cavity 24 becomes a predetermined low concentration that suppresses, as compared with the first measurement pump control processing, reduction of a first gas species (here, carbon dioxide), which is a part of oxide gas included among the reduction target gases in the measurement gas. By performing this second measurement pump control processing, in the second internal cavity 24, reduction target gases (here, water) other than the first gas species in the measurement gas are reduced to generate hydrogen and oxygen, while the reduction of the first gas species (here, carbon dioxide) in the measurement gas is suppressed. Then, the oxygen generated by the reduction of water and the oxygen existing in the measurement gas before the reduction are pumped from around the second measurement electrode 26 to around the outer pump electrode 40 by a pump current Ip2 flowing through the second measurement pump cell 25. Accordingly, the pump current Ip2 flowing through the second measurement pump cell 25 by the second measurement pump control processing is correlated with a total concentration of water (that is, the reduction target gases other than the first gas species) and oxygen in the measurement gas.

The control unit 96 performs third measurement pump control processing that controls the third measurement pump cell 35 so as to pump oxygen from around the third measurement electrode 36 to around the outer pump electrode 40. Specifically, the control unit 96 controls the third measurement pump cell 35 by feedback-controlling the voltage Vp3 of the variable power source 37 so that the voltage V3 reaches the target value V3*. The target value V3* is defined as a value such that an oxygen concentration in the third internal cavity 34 becomes a predetermined low concentration that suppresses, as compared with the second measurement pump control processing, reduction of a second gas species (here, water), which is one or more oxide gases other than the first gas species among the reduction target gases in the measurement gas. By performing this third measurement pump control processing, in the third internal cavity 34, reductions of the first gas species (here, carbon dioxide) and the second gas species (here, water) among the reduction target gases in the measurement gas are suppressed, and, if oxide gas(es) other than the first gas species and the second gas species exist among the reduction target gases, such oxide gas(es) are reduced to generate oxygen. Then, the oxygen generated by this reduction and the oxygen existing in the measurement gas before the reduction are pumped from around the third measurement electrode 36 to around the outer pump electrode 40 by a pump current Ip3 flowing through the third measurement pump cell 35. Accordingly, the pump current Ip3 flowing through the third measurement pump cell 35 by the third measurement pump control processing is correlated with a total concentration of the reduction target gases other than the first gas species and the second gas species and oxygen in the measurement gas. It is to be noted that, in this embodiment, as described above, the reduction target gases are water (the second gas species) and carbon dioxide (the first gas species), and therefore “the reduction target gases other than the first gas species and the second gas species in the measurement gas” do not exist. Thus, in this embodiment, the pump current Ip3 flowing through the third measurement pump cell 35 by the third measurement pump control processing is correlated with an oxygen concentration in the measurement gas.

Further, the control unit 96 performs first concentration measurement processing that measures a first concentration (here, a carbon dioxide concentration), which is a concentration of the first gas species (here, carbon dioxide) in the measurement gas, on the basis of a pump current Ip1 flowing through the first measurement pump cell 15 by the first measurement pump control processing and a pump current Ip2 flowing through the second measurement pump cell 25 by the second measurement pump control processing. As described above, the pump current Ip1 flowing through the first measurement pump cell 15 by the first measurement pump control processing is correlated with a total concentration of the reduction target gases and oxygen in the measurement gas. Also, the pump current Ip2 flowing through the second measurement pump cell 25 by the second measurement pump control processing is correlated with a total concentration of water (that is, the reduction target gases other than the first gas species) and oxygen in the measurement gas. Therefore, on the basis of the pump current Ip1 and the pump current Ip2, it is possible to measure the first concentration (here, the carbon dioxide concentration), which is the concentration of the first gas species (here, carbon dioxide) in the measurement gas. For example, the control unit 96 may measure the carbon dioxide concentration on the basis of a difference between the pump current Ip1 and the pump current Ip2. In this case, a first correspondence relationship between the difference between the pump current Ip1 and the pump current Ip2 and the carbon dioxide concentration may be stored in advance in the storage unit 98. The first correspondence relationship can be, for example, a relational expression such as a linear function or a map. This first correspondence relationship can be obtained in advance by experiments, analyses, and the like. Then, the control unit 96 can derive (measure) the carbon dioxide concentration by deriving the difference between the pump current Ip1 and the pump current Ip2 and, on the basis of the derived value and the first correspondence relationship stored in the storage unit 98.

The control unit 96 performs second concentration measurement processing that measures a second concentration (here, a water concentration), which is a concentration of the second gas species (here, water) in the measurement gas, on the basis of a pump current Ip2 flowing through the second measurement pump cell 25 by the second measurement pump control processing and a pump current Ip3 flowing through the third measurement pump cell 35 by the third measurement pump control processing. As described above, the pump current Ip2 flowing through the second measurement pump cell 25 by the second measurement pump control processing is correlated with a total concentration of water (that is, the reduction target gases other than the first gas species) and oxygen in the measurement gas. Also, the pump current Ip3 flowing through the third measurement pump cell 35 by the third measurement pump control processing is correlated with a total concentration of the reduction target gases other than the first gas species and the second gas species and oxygen in the measurement gas (here, an oxygen concentration in the measurement gas). Therefore, on the basis of the pump current Ip2 and the pump current Ip3, it is possible to measure the second concentration (here, the water concentration), which is the concentration of the second gas species (here, water) in the measurement gas. For example, the control unit 96 may measure the water concentration on the basis of a difference between the pump current Ip2 and the pump current Ip3. In this case, a second correspondence relationship between the difference between the pump current Ip2 and the pump current Ip3 and the water concentration may be stored in advance in the storage unit 98. The second correspondence relationship can be, for example, a relational expression such as a linear function or a map. This second correspondence relationship can be obtained in advance by experiments, analyses, and the like. Then, the control unit 96 can derive (measure) the water concentration by deriving the difference between the pump current Ip2 and the pump current Ip3 and, on the basis of the derived value and the second correspondence relationship stored in the storage unit 98.

The control unit 96 performs third concentration measurement processing that measures a third concentration, which is a total concentration of the reduction target gases other than the first gas species and the second gas species and oxygen in the measurement gas, on the basis of the pump current Ip3 flowing through the third measurement pump cell 35 by the third measurement pump control processing. As described above, in this embodiment, the oxide gases included in the reduction target gases are the first gas species (carbon dioxide) and the second gas species (water), and oxide gases other than those do not exist, and therefore an oxygen concentration in the measurement gas becomes the third concentration. Also, as described above, the pump current Ip3 flowing through the third measurement pump cell 35 by the third measurement pump control processing is correlated with the oxygen concentration in the measurement gas. Therefore, on the basis of this pump current Ip3, it is possible to measure the third concentration (here, the oxygen concentration) in the measurement gas. In this case, a third correspondence relationship between the pump current Ip3 and the oxygen concentration may be stored in advance in the storage unit 98. The third correspondence relationship can be, for example, a relational expression such as a linear function or a map. This third correspondence relationship can be obtained in advance by experiments, analyses, and the like. Then, the control unit 96 can derive (measure) the oxygen concentration on the basis of the pump current Ip3 and the third correspondence relationship stored in the storage unit 98.

The control unit 96 performs fourth concentration measurement processing that measures a fourth concentration, which is a total concentration of the first gas species and the second gas species (here, a total concentration of carbon dioxide and water) in the measurement gas, on the basis of the pump current Ip1 flowing through the first measurement pump cell 15 by the first measurement pump control processing and the pump current Ip3 flowing through the third measurement pump cell 35 by the third measurement pump control processing. As described above, the pump current Ip1 flowing through the first measurement pump cell 15 by the first measurement pump control processing is correlated with a total concentration of the reduction target gases and oxygen in the measurement gas. Also, the pump current Ip3 flowing through the third measurement pump cell 35 by the third measurement pump control processing is correlated with a total concentration of the reduction target gases other than the first gas species and the second gas species and oxygen in the measurement gas (here, an oxygen concentration in the measurement gas). Therefore, on the basis of the pump current Ip1 and the pump current Ip3, it is possible to measure the fourth concentration, which is the total concentration of the first gas species (here, carbon dioxide) and the second gas species (here, water) in the measurement gas. For example, the control unit 96 may measure the fourth concentration on the basis of a difference between the pump current Ip1 and the pump current Ip3. In this case, a fourth correspondence relationship between the difference between the pump current Ip1 and the pump current Ip3 and the fourth concentration may be stored in advance in the storage unit 98. The fourth correspondence relationship can be, for example, a relational expression such as a linear function or a map. This fourth correspondence relationship can be obtained in advance by experiments, analyses, and the like. Then, the control unit 96 can derive (measure) the water concentration by deriving the difference between the pump current Ip1 and the pump current Ip3 and, on the basis of the derived value and the fourth correspondence relationship stored in the storage unit 98.

The control unit 96 performs heater control processing by outputting a control signal to the heater power source 76 such that the temperature of the heater 72 reaches to a target temperature (e.g. 800° C.). Here, the temperature of the heater 72 can be expressed as a linear function of the resistance value of the heater 72. In the heater control processing, the control unit 96 calculates the resistance value of the heater 72, which is a value can be regarded as the temperature of the heater 72 (a value that can be converted into temperature), and feedback-controls the heater power source 76 such that the calculated resistance value reaches to a target resistance value (a value corresponding to the target temperature). The control unit 96 can acquire the voltage of the heater 72 and the current flowing through the heater 72, then calculate the resistance of the heater 72 based on the acquired voltage and current. The control unit 96 may use a three-wire or four-wire method to calculate the resistance, for example. The heater power source 76 adjusts the power supplied to the heater 72 by changing the voltage applied to the heater 72 based on a control signal from the control unit 96 when energizing the heater 72.

In addition, the control device 95, which includes the variable power sources 17, 27, 37, and the heater power source 76 shown in FIG. 2, is actually connected to the electrodes inside the sensor element 101 through unillustrated lead wires formed within the sensor element 101 and unillustrated connector electrodes formed at the rear end of the sensor element 101 (only the heater connector electrode 71 shown in FIG. 1).

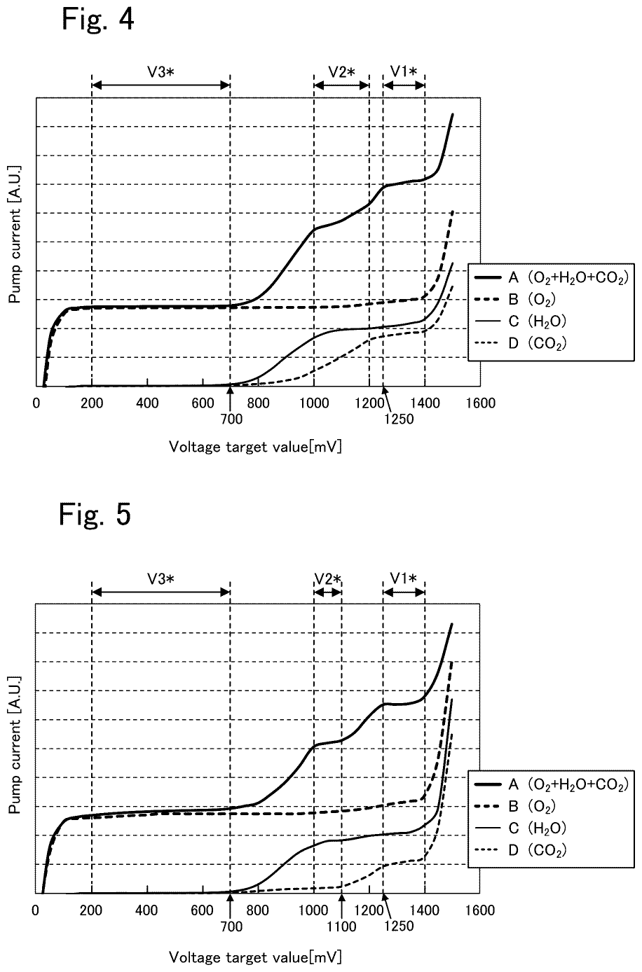

Here, an example of the target values V1*, V2*, and V3* described above will be explained. FIG. 4 is an explanatory diagram showing an example of a relationship (V-I characteristics) between voltage target values (V1*, V2*, V3*) and pump currents (Ip1, Ip2, Ip3) in the pump cells (the first to third measurement pump cells 15, 25, and 35). A thick solid-line graph A in FIG. 4 was obtained by examining a relationship between the voltage target value and the pump current in the pump cell in a case where a model gas, which uses nitrogen as a base gas and contains oxygen, water, and carbon dioxide, was used as the measurement gas. A thick dotted-line graph B was obtained by examining a relationship between the voltage target value and the pump current in the pump cell in a case where a model gas, which uses nitrogen as a base gas and contains oxygen and does not contain water and carbon dioxide, was used as the measurement gas. A thin solid-line graph C was obtained by examining a relationship between the voltage target value and the pump current in the pump cell in a case where a model gas, which uses nitrogen as a base gas and contains water and does not contain oxygen and carbon dioxide, was used as the measurement gas. A thin dotted-line graph D was obtained by examining a relationship between the voltage target value and the pump current in the pump cell in a case where a model gas, which uses nitrogen as a base gas and contains carbon dioxide and does not contain oxygen and water, was used as the measurement gas. FIG. 4 shows graphs for the gas sensor 100 in which the V-I characteristics of the first to third measurement pump cells 15, 25, and 35 are made identical to one another by, for example, making respective diffusion resistances of the first to third measurement gas flow paths identical to one another and also making the first to third measurement electrodes 16, 26, and 36 all electrodes of the same material. Therefore, in the explanation of FIG. 4 and FIG. 5 described later, the first to third measurement pump cells 15, 25, and 35 are not distinguished and are simply referred to as “the pump cell,” the target values V1*, V2*, and V3* are not distinguished and are simply referred to as “the voltage target value,” the pump currents Ip1, Ip2, and Ip3 are not distinguished and are simply referred to as “the pump current,” the first to third internal cavities 14, 24, and 34 are not distinguished and are simply referred to as “the internal cavity,” the first to third measurement electrodes 16, 26, and 36 are not distinguished and are simply referred to as “the inner electrode,” and the ratios R1, R2, and R3 are not distinguished and are simply referred to as “the ratio R,” in some cases. Also, FIG. 4 shows the V-I characteristics in a case where the inner electrode does not contain the second type of noble metal.

As shown in FIG. 4, in any of the graphs A to D, it was confirmed that the larger the absolute value of the voltage target value, the larger the pump current tends to be. It should be noted that, the larger the absolute value of the voltage target value is, the pump cell is controlled so as to adjust a target value of the oxygen concentration in the internal cavity lower with respect to the oxygen concentration of the reference gas around the reference electrode 42 (that is, to pump out more oxygen from the internal cavity).

In the graph D of FIG. 4, in a region where the voltage target value is 200 mV or more and 700 mV or less, the pump current is a substantially constant value close to zero, and in a region where the voltage target value exceeds 700 mV, the pump current increases as the voltage target value increases. In a region where the voltage target value is 1250 mV or more and 1400 mV or less, the pump current becomes a substantially constant value; that is, the pump current reaches a limiting current. This region is called a plateau region. From this graph D, it is understood that, in the region where the voltage target value exceeds 700 mV, carbon dioxide is reduced and oxygen generated by the reduction is pumped out by the pump current, and that, for carbon dioxide, the region where the voltage target value is 1250 mV or more and 1400 mV or less is the plateau region and, in this region, the pump current becomes a value correlated with the carbon dioxide concentration in the internal cavity. Similarly, from graph C, it is understood that, for water, the region where the voltage target value is 1000 mV or more and 1400 mV or less is the plateau region and, in this region, the pump current becomes a value correlated with the water concentration in the internal cavity. Further, from graph B, it is understood that, for oxygen, the region where the voltage target value is 200 mV or more and 1400 mV or less is the plateau region and, in this region, the pump current becomes a value correlated with the oxygen concentration in the internal cavity. From these graphs B to D, the lower limits of the voltage target values at which plateau regions appear are different among carbon dioxide, water, and oxygen; the lower limit of the voltage target value is lowest for oxygen (200 mV), next lowest for water (1000 mV), and highest for carbon dioxide (1250 mV). Therefore, since the lower limit of the voltage target value at which the plateau region appears is higher for carbon dioxide than for water, it is understood that carbon dioxide is more difficult to reduce than water.

In the graph A of FIG. 4, which shows V-I characteristics obtained using the measurement gas that contains oxygen, water, and carbon dioxide, three plateau regions appear corresponding to the respective plateau regions of graphs B to D. In this embodiment, the voltage target values (V1*, V2*, V3*) are set to be different from one another and to satisfy the absolute-value relationship |V3*|<|V2*|<|V1*|, and the target values V1*, V2*, and V3* are set to voltage target values corresponding to the three plateau regions of graph A, respectively. By doing so, the pump currents Ip1 to Ip3 can be made to correspond to different gas concentrations. Specifically, the target value V1* is set, as a predetermined value of 1250 mV or more and 1400 mV or less, to correspond to the region having the highest voltage target value among the three plateau regions of graph A. In this region, as is also understood from graphs B to D, carbon dioxide, water, and oxygen are all in their plateau regions, and pumping-out of oxygen in the measurement gas and reductions of water and carbon dioxide are performed. Therefore, by performing the first measurement pump control processing on the basis of the target value V1* set in this manner, the pump current Ip1 becomes a relatively large value, and the pump current Ip1 becomes a value correlated with the total concentration of water, carbon dioxide, and oxygen in the measurement gas. The target value V2* is set, as a predetermined value of 1000 mV or more and 1200 mV or less, to correspond to the region having the second highest voltage target value among the three plateau regions of graph A. As is also understood from graphs B to D, this region is the plateau region for water and oxygen, whereas it is outside the plateau region for carbon dioxide (a region where the voltage target value is lower than the plateau region for carbon dioxide). In this region, pumping-out of oxygen in the measurement gas and reduction of water are performed, while reduction of carbon dioxide is suppressed. Therefore, by performing the second measurement pump control processing on the basis of the target value V2* set in this manner, the pump current Ip2 becomes smaller than the pump current Ip1 by an amount corresponding to the suppression of reduction of carbon dioxide, and the pump current Ip2 becomes a value correlated with the total concentration of water and oxygen in the measurement gas. The target value V3* is set, as a predetermined value of 200 mV or more and 700 mV or less, to correspond to the region having the lowest voltage target value among the three plateau regions of graph A. As is also understood from graphs B to D, this region is the plateau region for oxygen, whereas it is outside the plateau regions for water and carbon dioxide (a region where the voltage target value is lower than the plateau regions for water and carbon dioxide). In this region, pumping-out of oxygen in the measurement gas is performed, while reductions of water and carbon dioxide are suppressed. Therefore, by performing the third measurement pump control processing on the basis of the target value V3* set in this manner, the pump current Ip3 becomes smaller than the pump current Ip2 by an amount corresponding to the suppression of reductions of water and carbon dioxide, and the pump current Ip3 becomes a value correlated with the oxygen concentration in the measurement gas.

As described above, even when the measurement gas contains oxygen, water, and carbon dioxide together (graph A of FIG. 4), by making the voltage target values different, it is possible to selectively suppress reduction of a part or all of the reduction target gases (here, water and carbon dioxide). More specifically, as the absolute value of the voltage target value is decreased, reductions of the reduction target gases (here, water and carbon dioxide) are suppressed in order from the gas that is more difficult to reduce (here, reduction of carbon dioxide is first suppressed, and next reduction of water is suppressed). By utilizing this, a correspondence relationship between the pump current and a gas concentration can be adjusted according to the voltage target value. In this embodiment, by setting the target values V1*, V2*, and V3* to the values described above, the pump current Ip1 is made to correspond to the total concentration of water, carbon dioxide, and oxygen, the pump current Ip2 is made to correspond to the total concentration of water and oxygen, and the pump current Ip3 is made to correspond to the oxygen concentration, so that the first to fourth concentrations described above can be measured.

Next, V-I characteristics in a case where the inner electrode contains the second type of noble metal will be described. FIG. 5 shows V-I characteristics of the pump cell when the inner electrode contains the second type of noble metal so that the ratio R becomes a value of 2% or more and 10% or less. The measurement gases for graphs A to D in FIG. 5 are the same as the respective measurement gases for graphs A to D in FIG. 4. Comparing graph D of FIG. 4 with graph D of FIG. 5, in both cases, when the voltage target value becomes 700 mV or more, the pump current increases (rises) as the voltage target value increases; however, in graph D of FIG. 5, compared with graph D of FIG. 4, in a region where the voltage target value is 900 mV or more and 1100 mV or less, the pump current hardly increases, and when the voltage target value exceeds 1100 mV, the pump current begins to increase. Further, in graph D of FIG. 5, as in graph D of FIG. 4, the region where the voltage target value is 1250 mV or more and 1400 mV or less is the plateau region; however, the increase width of the pump current up to the plateau region is smaller than that in graph D of FIG. 4. From these results, it was confirmed that, by causing the inner electrode to contain the second type of noble metal, reduction of carbon dioxide around the inner electrode is suppressed. In contrast, graphs B and C of FIG. 5 showed almost no change from graphs B and C of FIG. 4. That is, even if the inner electrode contains the second type of noble metal, reduction of water around the inner electrode is hardly suppressed, and pumping-out of oxygen by the pump cell is hardly affected. From the comparative results of FIGS. 4 and 5 as described above, it was confirmed that, by causing the inner electrode to contain the second type of noble metal, reduction of carbon dioxide is selectively suppressed.

Further, also in a comparison between graph A of FIG. 4 and graph A of FIG. 5, a tendency was confirmed that originates from the difference between graph D of FIG. 4 and graph D of FIG. 5 due to the selective suppression of reduction of carbon dioxide as described above. Specifically, the pump current of graph A in FIG. 4 is slightly inclined upward to the right in a region where the voltage target value is 1000 mV or more and 1200 mV or less, because it is influenced not only by the plateau region of graph C in FIG. 4 but also by the rise of the pump current in graph D of FIG. 4 (that is, reduction of carbon dioxide). In contrast, the pump current of graph A in FIG. 5, in a region where the voltage target value is 1000 mV or more and 1100 mV or less, reflects more strongly the shapes of the plateau regions of graph B and graph C in FIG. 5, and thus becomes flatter than graph A in FIG. 4, because, as described above, the increase of the pump current of graph D in FIG. 5 is suppressed. That is, the pump current of graph A in FIG. 5, in a region where the voltage target value is 1000 mV or more and 1100 mV or less, is less influenced by the pump current originating from reduction of carbon dioxide than graph A in FIG. 4. Therefore, when the second measurement electrode 26 contains the second type of noble metal, the target value V2* may be set, as a predetermined value of 1000 mV or more and 1100 mV or less, to correspond to the region having the second highest voltage target value among the three plateau regions of graph A in FIG. 5. In this way, the pump current Ip2 becomes less susceptible to influences of the carbon dioxide concentration in the measurement gas, and the pump current Ip2 corresponds to the total concentration of water and oxygen with higher accuracy. Therefore, when the carbon dioxide concentration is measured on the basis of the difference between the pump current Ip1 and the pump current Ip2, this difference corresponds to the carbon dioxide concentration with higher accuracy. As described above, by causing the second measurement electrode 26 to contain the second type of noble metal, measurement accuracy of the first concentration measurement processing, that is, measurement accuracy of the carbon dioxide concentration based on the pump currents Ip1 and Ip2, is improved. The reason why it is preferable that the second measurement electrode 26 contains the second type of noble metal is as described above.

As for the first measurement electrode 16, as described above, it suffices that the first measurement electrode 16 contains the first type of noble metal, and it may contain the second type of noble metal or may not contain the second type of noble metal. If the first measurement electrode 16 contains the second type of noble metal, then, as can be understood from the comparison between graph D of FIG. 4 and graph D of FIG. 5, although there is a tendency for a value of the pump current originating from reduction of carbon dioxide to become smaller in a region where the voltage target value is 1250 mV or more and 1400 mV or less, the plateau region for carbon dioxide appears. Therefore, if the voltage target value V1* is set as a predetermined value of 1250 mV or more and 1400 mV or less, the pump current Ip1 becomes a value correlated with a total concentration of water, carbon dioxide, and oxygen in the measurement gas. Accordingly, even if the first measurement electrode 16 contains the second type of noble metal, it is possible to measure the carbon dioxide concentration on the basis of the pump current Ip1 and the pump current Ip2. When the first measurement electrode 16 contains the second type of noble metal, the ratio R1 of the second type of noble metal in the first measurement electrode 16 may be 2% or more, and may be 5% or more. The ratio R1 may be 10% or less, and may be 5% or less. The ratio R1 may be a value not greater than the ratio R2, and may be a value smaller than the ratio R2.

As for the third measurement electrode 36, since it is used at a voltage target value (V3*) at which carbon dioxide is hardly reduced, as described above, it suffices that the third measurement electrode 36 contain the first type of noble metal, and the third measurement electrode 36 may contain the second type of noble metal or may not contain the second type of noble metal. Even when the third measurement electrode 36 contains the second type of noble metal, the target value V3* may be set, as in FIG. 4, as a predetermined value of 200 mV or more and 700 mV or less, to correspond to the region having the lowest voltage target value among the three plateau regions of graph A in FIG. 5. When the third measurement electrode 36 contains the second type of noble metal, the ratio R3 of the second type of noble metal in the third measurement electrode 36 may be 2% or more, and may be 5% or more. The ratio R3 may be 10% or less, and may be 5% or less. The ratio R3 may be a value not greater than the ratio R2, and may be a value smaller than the ratio R2.

The V-I characteristics of FIGS. 4 and 5 and the values of the target values V1*, V2*, and V3* are merely examples, and, for example, if the values of the respective diffusion resistances of the first to third measurement gas flow paths change, the numerical ranges of the voltage target values in which the three plateau regions appear in graph A of FIG. 4 may become different values. In such a case, the target values V1*, V2*, and V3* may be determined on the basis of the respective V-I characteristics of the first to third measurement pump cells 15, 25, and 35. However, it is preferable that the values of the respective diffusion resistances of the first to third measurement gas flow paths be close to one another or be the same. For example, in FIG. 2, the first buffer space 12 has a shorter length along the gas flow direction and a larger length perpendicular to the gas flow direction (that is, a larger width) than the second buffer space 22 and the third buffer space 32, and therefore the first buffer space 12 has a smaller diffusion resistance than the second buffer space 22 and the third buffer space 32. Even in such a case, for example, by making the diffusion resistance of the first diffusion rate-limiting portion 13 higher than the diffusion resistances of the second diffusion rate-limiting portion 23 and the third diffusion rate-limiting portion 33 (for example, by making a cross-sectional area of the slit of the first diffusion rate-limiting portion 13 smaller), the values of the respective diffusion resistances of the first to third measurement gas flow paths can be made close to one another or the same.

As shown in FIG. 2, in this embodiment, top-view areas of the first to third measurement electrodes 16, 26, and 36 are different from one another, the area of the first measurement electrode 16 being the largest, the area of the second measurement electrode 26 being the next largest, and the area of the third measurement electrode 36 being the smallest. This corresponds to the fact that, as described above, magnitudes of the pump currents flowing by the first to third measurement pump control processing are in the order Ip1>Ip2>Ip3. Since the larger the area of an inner electrode is, the higher the ability of the pump cell to pump out oxygen becomes, it is preferable that the inner electrode area be larger for a pump cell through which a larger pump current flows.

A usage example of the gas sensor 100 configured as described above will be explained below. In a state where the gas sensor 100 is attached to the pipe and so forth through which the measurement gas flows, the control unit 96 first performs the heater control processing described above to control the temperature of the heater 72 to become the target temperature. When the temperature of the heater 72 reaches the target temperature (or around the target temperature), the control unit 96 starts the first to third measurement pump control processing described above. While continuously performing the first to third measurement pump control processing, the control unit 96 acquires (measures) the pump currents Ip1 to Ip3 and performs the first to fourth concentration measurement processing on the basis of the acquired values to measure the concentration of the specific gas in the measurement gas (here, the first to fourth concentrations, that is, the carbon dioxide concentration, the water concentration, the oxygen concentration, and the total concentration of carbon dioxide and water).

Here, the correspondence relationship between the elements according to the present embodiment and the elements according to the present invention will be clarified. The sensor element 101 according to the present embodiment corresponds to the sensor element according to the present invention; the element body 102 corresponds to the element body; the first internal cavity 14 corresponds to the first chamber; the second internal cavity 24 corresponds to the second chamber; the third internal cavity 34 corresponds to the third chamber; the first measurement electrode 16 corresponds to the first inner electrode; the first measurement pump cell 15 corresponds to the first pump cell; the second measurement electrode 26 corresponds to the second inner electrode; the second measurement pump cell 25 corresponds to the second pump cell; the third measurement electrode 36 corresponds to the third inner electrode; the third measurement pump cell 35 corresponds to the third pump cell; the outer pump electrode 40 corresponds to the first outer electrode, the second outer electrode, and the third outer electrode; the control device 95 corresponds to the control device; the first measurement pump control processing corresponds to the first pump cell control processing; the second measurement pump control processing corresponds to the second pump cell control processing; the third measurement pump control processing corresponds to the third pump cell control processing; the pump current Ip1 corresponds to the first pump current; the pump current Ip2 corresponds to the second pump current; and the pump current Ip3 corresponds to the third pump current. Further, the voltage V1 corresponds to the first voltage, the target value V1* corresponds to the first voltage target value, the voltage V2 corresponds to the second voltage, the target value V2* corresponds to the second voltage target value, the voltage V3 corresponds to the third voltage, and the target value V3* corresponds to the third voltage target value. The first gas inlet 11 corresponds to the first inlet, the second gas inlet 21 corresponds to the second inlet, and the third gas inlet 31 corresponds to the third inlet.

According to the gas sensor 100 of the present embodiment described in detail above, the control device 95 measures the first to fourth concentrations respectively as the concentration of the specific gas, on the basis of the pump currents Ip1 to Ip3. Here, the pump current Ip1 flowing through the first measurement pump cell 15 by the first measurement pump control processing correlates with the total concentration of reduction target gases and oxygen in the measurement gas. The pump current Ip2 flowing through the second measurement pump cell 25 by the second measurement pump control processing correlates with the total concentration of water (that is, reduction target gases other than the first gas species) and oxygen in the measurement gas. The pump current Ip3 flowing through the third measurement pump cell 35 by the third measurement pump control processing correlates with the oxygen concentration in the measurement gas. Therefore, based on the pump current Ip1 and the pump current Ip2, it is possible to measure the first concentration (here, the carbon dioxide concentration), which is the concentration of the first gas species (here, carbon dioxide) in the measurement gas. Further, based on the pump current Ip2 and the pump current Ip3, it is possible to measure the second concentration (here, the water concentration), which is the concentration of the second gas species (here, water) in the measurement gas. Based on the pump current Ip3, it is possible to measure the third concentration (here, the oxygen concentration) in the measurement gas. Based on the pump current Ip1 and the pump current Ip3, it is possible to measure the fourth concentration, which is the total concentration of the first gas species (here, carbon dioxide) and the second gas species (here, water) in the measurement gas. Moreover, in the gas sensor 100, the first internal cavity 14, the second internal cavity 24, and the third internal cavity 34 are not in communication with one another, and the measurement gas reaches the first internal cavity 14, the second internal cavity 24, and the third internal cavity 34 through respective independent routes from outside the sensor element 101. Therefore, it is possible to suppress gases in the first internal cavity 14, the second internal cavity 24, and the third internal cavity 34 from affecting one another, and the decrease in measurement accuracy due to the back diffusion described above is less likely to occur. For example, if the first internal cavity 14 and the second internal cavity 24 were in communication with each other inside the sensor element 101, hydrogen and carbon monoxide generated by reductions of water and carbon dioxide in the first internal cavity 14 could reach the second internal cavity 24, whereby measurement accuracy of the first concentration and/or the second concentration based on the pump current Ip2 could decrease, but, in the gas sensor 100 of this embodiment, such a situation is less likely to occur. Accordingly, in this gas sensor 100, it is possible to suppress the decrease in measurement accuracy of the concentration of the specific gas in the measurement gas.

Further, by causing the second measurement electrode 26 to contain the second type of noble metal in addition to the first type of noble metal, the pump current Ip2 becomes less susceptible to influences of a carbon dioxide concentration in the measurement gas. Therefore, measurement accuracy of the first concentration measurement processing, that is, measurement accuracy of the carbon dioxide concentration based on the pump currents Ip1 and Ip2, is improved. In addition, by making the ratio R2 of the second measurement electrode 26 be 2% or more, it is possible to more reliably weaken a reduction ability of the second measurement electrode 26 with respect to carbon dioxide.

Furthermore, since the first gas inlet 11, the second gas inlet 21, and the third gas inlet 31 open on surfaces different from one another among the first to sixth surfaces 102a to 102f, it is possible to further suppress gases in the first internal cavity 14, the second internal cavity 24, and the third internal cavity 34 from affecting one another.

It should be noted that the present invention is not limited to the present embodiment described above in any way, and it goes without saying that the present invention can be implemented in various aspects as long as they fall within the technical scope of the present invention.

For example, in the embodiment described above, the control device 95 performed the first to fourth concentration measurement processing to measure the first to fourth concentrations, but it suffices to perform at least two among the first to fourth concentration measurement processing. In this case, among the first to fourth concentration measurement processing, it is permissible to perform at least two processing selected in a combination such that all of the pump currents Ip1 to Ip3 are utilized. For example, a combination in which only the second concentration measurement processing and the third concentration measurement processing are performed is not preferable because the pump current Ip1 is not utilized. Also, a combination in which only the third concentration measurement processing and the fourth concentration measurement processing are performed is not preferable because the pump current Ip2 is not utilized. Further, the control device 95 may omit the fourth concentration measurement processing. That is, the control device 95 may perform the first to third concentration measurement processing to measure the first to third concentrations.

In the embodiment described above, in the first concentration measurement processing, the control device 95 measured the first concentration on the basis of the difference between the pump current Ip1 and the pump current Ip2, but the present invention is not limited thereto, and it suffices that the first concentration be measured on the basis of the pump current Ip1 and the pump current Ip2. For example, in the first concentration measurement processing, the control device 95 may derive, on the basis of the pump current Ip1, a total concentration of the reduction target gases and oxygen in the measurement gas (also referred to as a first total concentration), and may derive, on the basis of the pump current Ip2, a total concentration of the reduction target gases other than the first gas species and oxygen in the measurement gas (also referred to as a second total concentration), and then may derive (measure) a difference between the first total concentration and the second total concentration as the first concentration. In this case, a correspondence relationship between the pump current Ip1 and the first total concentration, and a correspondence relationship between the pump current Ip2 and the second total concentration, are stored in the storage unit 98 in advance, and the control device 95 may measure the first total concentration, the second total concentration, and the first concentration by using the pump currents Ip1 and Ip2 and these correspondence relationships. The same concept can be applied to measurement of the second concentration and the fourth concentration. For example, in the second concentration measurement processing, the control device 95 may derive the second total concentration on the basis of the pump current Ip2, may derive, on the basis of the pump current Ip3, a total concentration of the reduction target gases other than the first gas species and the second gas species and oxygen in the measurement gas (also referred to as a third total concentration), and then may derive (measure) a difference between the second total concentration and the third total concentration as the second concentration. In the fourth concentration measurement processing, the control device 95 may derive the first total concentration on the basis of the pump current Ip1, may derive the third total concentration on the basis of the pump current Ip3, and then may derive (measure) a difference between the first total concentration and the third total concentration as the fourth concentration.

In the embodiment described above, it was assumed that a correspondence relationship between the difference between the pump current Ip1 and the pump current Ip2 and the carbon dioxide concentration is stored in the storage unit 98 as a first correspondence relationship; however, a correspondence relationship among the pump current Ip1, the pump current Ip2, and the first concentration may be stored in the storage unit 98 as the first correspondence relationship. In this case, the control device 95 may derive the first concentration on the basis of the pump currents Ip1 and Ip2 and the first correspondence relationship, without deriving the difference between the pump current Ip1 and the pump current Ip2. The same concept can be applied to measurement of the second concentration and the fourth concentration.

In the embodiment described above, in the first concentration measurement processing, the control device 95 measured the first concentration on the basis of the difference between the pump current Ip1 and the pump current Ip2; however, it is also permissible to correct at least one of the pump current Ip1 and the pump current Ip2 and then derive the difference, and to measure the first concentration on the basis of the difference. That is, in the first concentration measurement processing, the control device 95 may measure the first concentration on the basis of the difference between a pump current Ip1′, which is the pump current Ip1 after correction, and the pump current Ip2; may measure the first concentration on the basis of the difference between the pump current Ip1 and a pump current Ip2′, which is the pump current Ip2 after correction; or may measure the first concentration on the basis of the difference between the pump current Ip1′ and the pump current Ip2′. These aspects are also included in aspect “measuring the first concentration on the basis of the difference between the pump current Ip1 and the pump current Ip2.” It is preferable that correction of at least one of the pump current Ip1 and the pump current Ip2 be performed so that a difference between a sensitivity of the pump current Ip1 to gases and a sensitivity of the pump current Ip2 to gases becomes smaller. Basically, it suffices that correction be performed on either of the pump currents Ip1 and Ip2, but, as described above, correction may be performed on both. Here, for example, if the ratio R1 of the second type of noble metal in the first measurement electrode 16 and the ratio R2 of the second type of noble metal in the second measurement electrode 26 are different, V-I characteristics of the first measurement pump cell 15 and the second measurement pump cell 25 may differ, as shown in FIGS. 4 and 5. Also, as described above, if values of diffusion resistances differ between the first measurement gas flow path and the second measurement gas flow path, V-I characteristics of the first measurement pump cell 15 and the second measurement pump cell 25 may differ. When V-I characteristics of the first measurement pump cell 15 and the second measurement pump cell 25 differ, a difference may arise between the sensitivity of the pump current Ip1 to gases and the sensitivity of the pump current Ip2 to gases. For example, when compositions of the measurement gas in the first internal cavity 14 and the second internal cavity 24 are the same and the carbon dioxide concentration is 0%, if the sensitivities to gases of the first measurement pump cell 15 and the second measurement pump cell 25 are the same, values of the pump current Ip1 flowing by the first measurement pump control processing and the pump current Ip2 flowing by the second measurement pump control processing basically become the same. In contrast, if there is a difference in sensitivities to gases between the first measurement pump cell 15 and the second measurement pump cell 25, even when compositions of the measurement gas in the first internal cavity 14 and the second internal cavity 24 are the same and the carbon dioxide concentration is 0%, a deviation may occur between the value of the pump current Ip1 flowing by the first measurement pump control processing and the value of the pump current Ip2 flowing by the second measurement pump control processing. When there is such a difference in sensitivities to gases between the first measurement pump cell 15 and the second measurement pump cell 25, since the difference between the pump current Ip1 and the pump current Ip2 includes not only the carbon dioxide concentration but also the above-described deviation, by correcting at least one of the pump current Ip1 and the pump current Ip2 so that the deviation becomes smaller, a difference after the correction corresponds to the carbon dioxide concentration with higher accuracy. The correction of the pump current Ip1 may be performed, for example, by multiplying the pump current Ip1 by a predetermined correction coefficient. For example, if a value of the pump current Ip2 when compositions of the measurement gas in the first internal cavity 14 and the second internal cavity 24 are the same and the carbon dioxide concentration is 0% becomes 0.9 times a value of the pump current Ip1, a value obtained by multiplying the pump current Ip1 by a correction coefficient of 0.9 may be taken as the corrected pump current Ip1′. The correction of the pump current Ip1 may also be performed by deriving the pump current Ip1′ using a correspondence relationship between the pump current Ip1 and the corrected pump current Ip1′. Such correction coefficients or correspondence relationships can be obtained in advance by experiments or analyses and stored in the storage unit 98. The correction of the pump current Ip2 can be performed similarly. The same concept can be applied to measurement of the second concentration and the fourth concentration. For example, in the second concentration measurement processing, the control device 95 may correct at least one of the pump current Ip2 and the pump current Ip3, then derive the difference, and measure the second concentration on the basis of the difference. This aspect is also included in the aspect “measuring the second concentration on the basis of the difference between the pump current Ip2 and the pump current Ip3.” In the fourth concentration measurement processing, the control device 95 may correct at least one of the pump current Ip1 and the pump current Ip3, then derive the difference, and measure the fourth concentration on the basis of the difference. This aspect is also included in the aspect “measuring the fourth concentration on the basis of the difference between the pump current Ip1 and the pump current Ip3.”

In the embodiment described above, the reduction target gases are taken as water and carbon dioxide, the first gas species is taken as carbon dioxide, and the second gas species is taken as water, but the present invention is not limited thereto. The reduction target gases are not limited to water and carbon dioxide, and may be oxide gases of two or more kinds in the measurement gas. The first gas species may be the gas that one or more kinds of oxide gas included among the reduction target gases, but not all kinds thereof. One or more kinds of oxide gas other than the first gas species among the reduction target gases can be taken as the second gas species. Note that the first gas species is one or more kinds of oxide gases selected in order from an oxide gas that is most difficult to reduce among two or more oxide gases included in the reduction target gases. Also, the second gas species is one or more kinds of oxide gases selected in order from oxide gases that are most difficult to reduce among the oxide gases other than the first gas species in the reduction target gases. For example, consider a case where the reduction target gases are four kinds, namely, gas a, gas b, gas c, and gas d, and these are oxide gases that are more difficult to reduce in this order. In this case, the first gas species is selected in order from oxide gases that are more difficult to reduce among the reduction target gases, such as, for example, gas a, or gas a and gas b. When the first gas species is gas a, the second gas species is selected in order from oxide gases other than the first gas species in the reduction target gases that are more difficult to reduce, such as, for example, gas b, or gas b and gas c. In the embodiment described above, since the reduction target gases are water and carbon dioxide, among these, carbon dioxide, which is more difficult to reduce, is taken as the first gas species, and water, which is an oxide gas other than this, is taken as the second gas species. Two or more gases including carbon dioxide may be taken as the first gas species. Two or more gases including water may be taken as the second gas species. Note that, even if an oxide gas is included in the measurement gas, the oxide gas that is not reduced by any of the processing performed by the control device 95 (at least two of the first to fourth concentration measurement processing being selected in a combination that uses all of the pump currents Ip1 to Ip3) is not the reduction target gas.

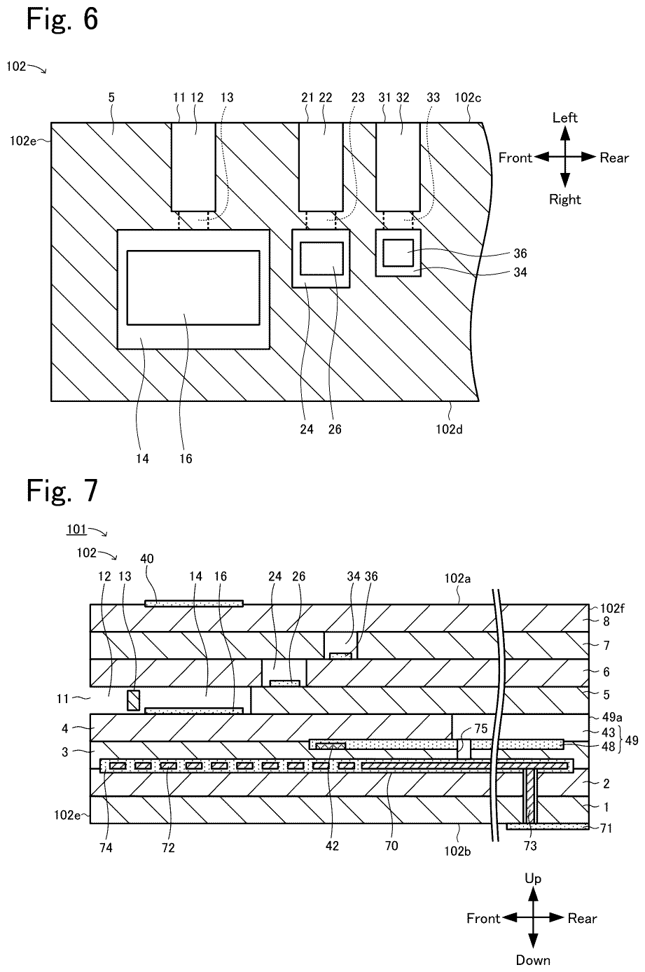

In the embodiment described above, the first gas inlet 11, the second gas inlet 21, and the third gas inlet 31 open on mutually different surfaces among the first to sixth surfaces 102a to 102f; however, the present invention is not limited thereto. Two among the first gas inlet 11, the second gas inlet 21, and the third gas inlet 31 may open on a same surface among the first to sixth surfaces 102a to 102f. Moreover, as in the element body 102 of the modified example shown in FIG. 6, the first gas inlet 11, the second gas inlet 21, and the third gas inlet 31 may open on a same surface among the first to sixth surfaces 102a to 102f. In the modified example of FIG. 6, the first gas inlet 11, the second gas inlet 21, and the third gas inlet 31 all open on the third surface 102c. As a result, even when a concentration of a specific gas in the measurement gas varies in a short time, the measurement gas that reaches each of the first, second, and third internal cavities 14, 24, and 34 is likely to have the same concentration of a specific gas. Accordingly, measurement accuracy of concentrations (the first, second, and fourth concentrations) measured on the basis of two among the first to third pump currents is improved.

In the embodiment described above, the first internal cavity 14, the second internal cavity 24, and the third internal cavity 34 were all spaces formed by hollowing out the spacer layer 5; however, the present invention is not limited thereto. Two or more among the first internal cavity 14, the second internal cavity 24, and the third internal cavity 34 may be formed in mutually different layers among a plurality of layers included in the element body 102. For example, as in the element body 102 according to a modification shown in FIG. 7, the first internal cavity 14, the second internal cavity 24, and the third internal cavity 34 may be formed in mutually different layers. In the modification of FIG. 7, the element body 102 includes, in addition to the layers 1 to 6 of the embodiment described above, a third solid electrolyte layer 7 and a fourth solid electrolyte layer 8. The first internal cavity 14 is formed by hollowing out the spacer layer 5, the second measurement pump cell 25 is formed by hollowing out the second solid electrolyte layer 6, and the third measurement pump cell 35 is formed by hollowing out the third solid electrolyte layer 7. Furthermore, the outer pump electrode 40 is disposed on the upper surface of the fourth solid electrolyte layer 8, which is the first surface 102a of the element body 102.

In the embodiment described above, it is permissible to omit any one among the first internal cavity 14, the second internal cavity 24, and the third internal cavity 34 included in the element body 102 of the sensor element 101. In this case, the two internal cavities that are not omitted among the first internal cavity 14, the second internal cavity 24, and the third internal cavity 34 correspond to the first chamber and the second chamber of the second gas sensor of the present invention. Even in this case, the control device 95 may perform processing corresponding to the two internal cavities that are not omitted among the first to third measurement pump control processing of the embodiment described above, to cause two among the pump currents Ip1 to Ip3 to flow, and to measure a concentration of a specific gas on the basis of those two pump currents. For example, when the third internal cavity 34 is omitted, the control unit 96 may measure, as the concentration of the specific gas, the first gas species (for example, a carbon dioxide concentration) in the measurement gas on the basis of the pump current Ip1 flowing through the first measurement pump cell 15 by the first measurement pump control processing and the pump current Ip2 flowing through the second measurement pump cell 25 by the second measurement pump control processing. The same concept can be applied to cases where the first internal cavity 14 is omitted or where the second internal cavity 24 is omitted.

In the embodiment described above, the outer pump electrode 40 plays a role as the first outer electrode paired with the first measurement electrode 16 in the first measurement pump cell 15, a role as the second outer electrode paired with the second measurement electrode 26 in the second measurement pump cell 25, and a role as the third outer electrode paired with the third measurement electrode 36 in the third measurement pump cell 35. That is, the first to third outer electrodes are configured as the common outer pump electrode 40. However, the present invention is not limited thereto. For example, two among the first to third outer electrodes may be configured as a common electrode and the remaining one may be disposed, as an electrode independent of the outer pump electrode 40, on an outer surface of the element body 102. Alternatively, the first to third outer electrodes may be provided, as respective independent electrodes, on an outer surface of the element body 102.

What is claimed is:

1. A gas sensor comprising a sensor element and a control device, and configured to measure a concentration of a specific gas in a measurement gas,
wherein:
the sensor element includes:
an element body having an oxygen-ion-conductive solid electrolyte layer and having, inside the element body, a first chamber, a second chamber, and a third chamber that are not in communication with each other and that are each reachable by the measurement gas from outside the sensor element;
a first pump cell constituted including a first inner electrode disposed in the first chamber and a first outer electrode disposed on an outer surface of the element body;
a second pump cell constituted including a second inner electrode disposed in the second chamber and a second outer electrode disposed on an outer surface of the element body; and
a third pump cell constituted including a third inner electrode disposed in the third chamber and a third outer electrode disposed on an outer surface of the element body;
the control device performs:
a first pump cell control processing in which oxygen is pumped out from around the first inner electrode to around the first outer electrode by controlling the first pump cell, thereby reducing reduction target gases that are oxide gases of two or more kinds in the measurement gas in the first chamber;
a second pump cell control processing in which, by controlling the second pump cell, oxygen is pumped out from around the second inner electrode to around the second outer electrode, while suppressing, as compared with the first pump cell control processing, the reduction of a first gas species in the measurement gas in the second chamber, the first gas species being one or more kinds of oxide gas included among the reduction target gases, but not all kinds thereof; and
a third pump cell control processing in which, by controlling the third pump cell, oxygen is pumped out from around the third inner electrode to around the third outer electrode, while suppressing, as compared with the second pump cell control processing, the reduction of a second gas species in the measurement gas in the third chamber, the second gas species being one or more kinds of oxide gas other than the first gas species, included among the reduction target gases; and
the control device measures, as the concentration of the specific gas, at least two of the first to fourth concentrations by performing at least two types of the following concentration measurement processing, the at least two types being selected in a combination that uses all of the first to third pump currents:
a first concentration measurement processing in which a first concentration, which is a concentration of the first gas species in the measurement gas, is measured based on a first pump current that flows through the first pump cell by the first pump cell control processing and a second pump current that flows through the second pump cell by the second pump cell control processing;
a second concentration measurement processing in which a second concentration, which is a concentration of the second gas species in the measurement gas, is measured based on the second pump current and a third pump current that flows through the third pump cell by the third pump cell control processing;
a third concentration measurement processing in which a third concentration, which is a total concentration of the reduction target gases other than the first gas species and the second gas species and oxygen in the measurement gas, is measured based on the third pump current; and
a fourth concentration measurement processing in which a fourth concentration, which is a total concentration of the first gas species and the second gas species in the measurement gas, is measured based on the first pump current and the third pump current.

2. The gas sensor according to claim 1,
wherein the reduction target gases are water and carbon dioxide,
the first gas species is carbon dioxide, and
the second gas species is water.

3. The gas sensor according to claim 2,
wherein the second inner electrode contains a first type of noble metal with catalytic activity and a second type of noble metal that suppresses reduction of carbon dioxide.

4. The gas sensor according to claim 3,
wherein the first type of noble metal is at least one of Pt, Rh, Ir, Ru, and Pd, and
the second type of noble metal is Au.

5. The gas sensor according to claim 3,
wherein the second inner electrode has a ratio R2 calculated by the following Expression (1) of 2% or more,
$$R 2 = S 2 / ( S 1 + S 2 ) * 100 \qquad ( 1 )$$
where
S1: mass ratio [wt %] of the first type of noble metal; and
S2: mass ratio [wt %] of the second type of noble metal.

6. The gas sensor according to claim 1,
wherein the sensor element includes a reference electrode disposed inside the element body so as to be in contact with a reference gas, and
the control device controls:
in the first pump cell control processing, the first pump cell such that a first voltage, which is a voltage between the reference electrode and the first inner electrode, reaches a first voltage target value;
in the second pump cell control processing, the second pump cell such that a second voltage, which is a voltage between the reference electrode and the second inner electrode, reaches a second voltage target value whose absolute value is smaller than the absolute value of the first voltage target value; and
in the third pump cell control processing, the third pump cell such that a third voltage, which is a voltage between the reference electrode and the third inner electrode, reaches a third voltage target value whose absolute value is smaller than the absolute value of the second voltage target value.

7. The gas sensor according to claim 1,
wherein the first concentration measurement processing is processing that measures the first concentration based on a difference between the first pump current and the second pump current, or processing that measures the first concentration based on a difference between a total concentration of the reduction target gases and oxygen in the measurement gas derived based on the first pump current and a total concentration of the reduction target gases other than the first gas species and oxygen in the measurement gas derived based on the second pump current;
the second concentration measurement processing is processing that measures the second concentration based on a difference between the second pump current and the third pump current, or processing that measures the second concentration based on a difference between a total concentration of the reduction target gases other than the first gas species and oxygen in the measurement gas derived based on the second pump current and a total concentration of the reduction target gases other than the first gas species and the second gas species and oxygen in the measurement gas derived based on the third pump current; and
the fourth concentration measurement processing is processing that measures the fourth concentration based on a difference between the first pump current and the third pump current, or processing that measures the fourth concentration based on a difference between a total concentration of the reduction target gases and oxygen in the measurement gas derived based on the first pump current and a total concentration of the reduction target gases other than the first gas species and the second gas species and oxygen in the measurement gas derived based on the third pump current.

8. The gas sensor according to claim 1,
wherein the element body has a rectangular parallelepiped shape having first to sixth surfaces as outer surfaces,
the element body includes:
a first inlet that is an inlet of the measurement gas from outside to the first chamber,
a second inlet that is an inlet of the measurement gas from outside to the second chamber, and
a third inlet that is an inlet of the measurement gas from outside to the third chamber, and
the first inlet, the second inlet, and the third inlet open on mutually different surfaces among the first to sixth surfaces.

9. The gas sensor according to claim 1,
wherein the element body has a rectangular parallelepiped shape having first to sixth surfaces as outer surfaces,
the element body includes:
a first inlet that is an inlet of the measurement gas from outside to the first chamber,
a second inlet that is an inlet of the measurement gas from outside to the second chamber, and
a third inlet that is an inlet of the measurement gas from outside to the third chamber, and
the first inlet, the second inlet, and the third inlet open on a same surface among the first to sixth surfaces.

10. A gas sensor comprising a sensor element and a control device, and configured to measure a concentration of a specific gas in a measurement gas,
wherein:
the sensor element includes:
an element body having an oxygen-ion-conductive solid electrolyte layer and having, inside the element body, a first chamber and a second chamber that are not in communication with each other and that are each reachable by the measurement gas from outside the sensor element;
a first pump cell constituted including a first inner electrode disposed in the first chamber and a first outer electrode disposed on an outer surface of the element body;
a second pump cell constituted including a second inner electrode disposed in the second chamber and a second outer electrode disposed on an outer surface of the element body; and
the control device performs:
a first pump cell control processing in which oxygen is pumped out from around the first inner electrode to around the first outer electrode by controlling the first pump cell, thereby reducing reduction target gas that includes at least water among water and carbon dioxide in the measurement gas in the first chamber;
a second pump cell control processing in which, by controlling the second pump cell, oxygen is pumped out from around the second inner electrode to around the second outer electrode, while suppressing, as compared with the first pump cell control processing, the reduction of a first gas species in the measurement gas in the second chamber, the first gas species being one or more kinds of gas included among the reduction target gas; and
a concentration measurement processing in which a first concentration as the concentration of the specific gas, which is a concentration of the first gas species in the measurement gas, is measured based on a first pump current that flows through the first pump cell by the first pump cell control processing and a second pump current that flows through the second pump cell by the second pump cell control processing; and
the first gas species is water when the reduction target gas is water, and the first gas species is one or more kinds of gases including at least carbon dioxide among the reduction target gas when the reduction target gas is water and carbon dioxide.

11. A sensor element for measuring a concentration of a specific gas in a measurement gas, the sensor element comprising:
an element body having an oxygen-ion-conductive solid electrolyte layer and having, inside the element body, a first chamber, a second chamber, and a third chamber that are not in communication with each other and that are each reachable by the measurement gas from outside;
a first pump cell constituted including a first inner electrode disposed in the first chamber and a first outer electrode disposed on an outer surface of the element body;
a second pump cell constituted including a second inner electrode disposed in the second chamber and a second outer electrode disposed on an outer surface of the element body; and
a third pump cell constituted including a third inner electrode disposed in the third chamber and a third outer electrode disposed on an outer surface of the element body.
